(19) United States
(12) Patent Application Publication
(10) Pub. No.: US 2024/0306038 A1
(43) Pub. Date: Sep. 12, 2024

(54) Seamless Broadcast Segments Acquisition during Mobility

(71) Applicant: Telefonaktiebolaget LM Ericsson (publ), Stockholm (SE)

(72) Inventors: Ali Nader, Malmö (SE); Gertie Alsenmyr, Vallentuna (SE); Maria Hultström, Stockholm (SE); Carin Omurcali, Solna (SE); Martin van der Zee, Malmö (SE)

(21) Appl. No.: 18/289,249

(22) PCT Filed: Apr. 14, 2022
(86) PCT No.: PCT/SE2022/050375

§ 371 Date: Nov. 2, 2023

Related U.S. Application Data
(60) Provisional application No. 63/183,143, filed on May 3, 2021.

(51) Int. Cl. H04W 28/06; H04W 48/08

(52) U.S. Cl. CPC H04W 28/065; H04W 48/08

(57) ABSTRACT

Techniques for providing and receiving system information messages from a wireless network. An example method, in a user equipment, UE, comprises receiving (510) at least one segment of a segmented system information block, SIB, in a first cell and receiving (520) at least one other segment of the SIB in a second cell. The example method further comprises determining (530), based on information received from the wireless network, whether the at least one segment of the SIB received in the first cell can be concatenated with the at least one other segment of the SIB received in the second cell. The example method still further comprises concatenating (540) the at least one segment received in the first cell with the at least one other segment received in the second cell, to form the SIB, or discarding the at least one segment received in the first cell, depending on said information.

### TECHNICAL FIELD

This disclosure is generally related to wireless communications networks and is more particularly related to the broadcast of system information in such networks.

### BACKGROUND

In the 5^{th}-generation (5G) radio access network (RAN) under development by members of the 3rd-Generation Partnership Project (3GPP) and commonly referred to as “NR,” each gNB, i.e., the 5G base station, of the network (NW) broadcasts system information for user equipments (UEs) so that they can acquire necessary configuration parameters, such as for cell reselection, cell access, Sidelink communications (direct wireless terminal-to-terminal communications), positioning, etc., as well as information contents applicable to Public Warning Systems (PWS), which include the Earthquake and Tsunami Warning System (ETWS) and the Commercial Mobile Alert System (CMAS).

This system information is organized as a tree, with the Master Information Block (MIB) on the top containing only the most essential parameters broadcast on the Physical Broadcast Channel (PBCH). The remainder of the system information is broadcast in System Information Blocks (SIBx) contained in system information (SI) messages (except for SIB1) on the Physical Downlink Shared Channel (PDSCH). A SIB groups together Information Elements (IE) of the same nature, i.e., including same type of information, same broadcast periodicity, etc. FIG. 1 illustrates the tree-shaped relationship between the MIB, SIB1, and various SIBx messages.

The network can indicate in SIB1, via an areaScope parameter (boolean) for a given SIBx (x>1), whether the SIBx is cell-specific or area-specific. When the SIB is cell-specific the UE that receives and stores the SIB can only use the stored SIB info while camped in that cell. Otherwise, the UE can use the stored SIB info (i.e., content) so long as the cell in which the UE is camping belongs to same systemInformationAreaID (24-bit string), i.e., the systemInformationAreaID in SIB1 and in the stored info match.

3GPP has specified an upper limit on the size of SIB1 or any of the SI messages. A UE is not expected to receive a PDSCH assignment related to system information exceeding 2976 bits. There are, however, cases in which the intended contents to be carried by an SI message exceed this upper limit. Hence, a segmentation process is used whereby the network (NW) broadcasts the complete message in multiple instances of the SIs of same type, each containing a part (i.e., segment) of the complete message. The UE receives and concatenate these segments in lower layers, e.g., the Radio Resource Control (RRC) layer below, before a complete message is provided to its higher layers, e.g., layers above the RRC layer. Examples of SIBs which typically exceed this upper limit and are thus subject to this segmentation process are SIB7 (PWS ETWS contents), SIB8 (PWS CMAS contents), SIB12 (Sidelink configuration), and posSIBs (Positioning assistance data). Each of these SIBs may, in the current versions of the 3GPP specifications, be segmented in up to 64 segments depending on content size.

The segmentation process takes place in different parts of the NW depending on SIB type. For example, the positioning related SIBs (posSIBs) are segmented outside of gNBs, by the location server LMF (location management function), whereby the LMF provides the segmented contents transparently via the Access and Mobility Function (AMF) to the gNBs, and then further provided/broadcast to the UEs, which assemble the segments from the broadcast SI messages. FIG. 2 illustrates this process (based on 3GPP TS 23.273).

For other SIBs such as for PWS related SIBs (SIB7, and SIB8), and Sidelink related SIB12, the segmentation is done inside the gNB. The gNB may consist of a Central Unit (CU) and a Distributed Unit (DU) as depicted in FIG. 3. The gNB-CU and gNB-DU are connected using the F1 interface, as specified in 3GPP TS 38.473, which describes procedures for interface establishment, unlocking cells, configuration updates, paging, Public Warning Systems (PWS), etc. The segmentation of these SIBs can either be done by the gNB-CU (e.g., as for SIB7/8), or by the gNB-DU (e.g., as for SIB12).

There remain certain challenges.

### SUMMARY

For several reasons that are discussed in greater detail below, UEs involved in frequent cell reselections (e.g., UEs in high speed, or UEs on cell edge reselecting back and forth between cells), will suffer from delayed acquisition time of SIBs that have a large number of segments or may be unable to complete the acquisition at all, due to constant deletion and reacquisition/reassembly of segments before the information is presented to higher layers/user. Such delays, especially in the case of PWS, are highly undesirable. Therefore, there is a need for improved methods to remedy the issue.

Certain aspects of the disclosure and their embodiments may provide solutions to these or other challenges. According to several of the techniques described in detail below, broadcast system information is extended by new information elements that informs the UE whether the segments transmitted in various different cells have undergone the same segmentation process. If the UE sees that same segmentation is used for an SI in different cells (cells belong to the same segmentation area), the UE may then concatenate segments from various cells instead of throwing them away.

An example method according to some of the techniques described in detail below is performed by a user equipment (UE), for receiving system information messages from a wireless network. This example method comprises the steps of receiving at least one segment of a segmented SIB in a first cell and receiving at least one other segment of the SIB in a second cell. The method comprises the step of determining, based on information received from the wireless network, whether the at least one segment of the SIB received in the first cell can be concatenated with the at least one other segment of the SIB received in the second cell. The UE then concatenates the at least one segment received in the first cell with the at least one other segment received in the second cell, to form the SIB, or discards the at least one segment received in the first cell, depending on the received information.

An example method according to some of the other techniques described below is performed by a network node for providing system information to UE. This example method comprises the step of transmitting, in at least a first cell, multiple segments of a SIB. The method further comprises transmitting information indicating whether segments of the SIB transmitted in the first cell can be concatenated by a UE with one or more segments of the SIB received by the UE in a second cell.

Still another example method is also performed by a network node, for providing system information to a UE. This method, which is performed by a first network node, comprises the step of segmenting a SIB into multiple segments. This method further comprises forwarding the multiple segments to a second network node for transmission (by the second network node or other network node) to the UE, along with an indication of whether the same segmentation of the SIB is applicable to segments of the SIB sent to one or more other network nodes.

Also described herein are apparatuses and systems corresponding to the above-summarized methods and others.

Certain embodiments may provide one or more of the following technical advantages. The disclosed techniques may be used to mitigate the risk of a high-speed UE not being able to gather segmented SIBs due to constant cell change. The techniques may also provide faster acquisition of segmented SIBs for mobile UEs and/or UEs at cell edge reselecting between cells.

### BRIEF DESCRIPTION OF THE FIGURES

FIG. 1 illustrates the tree structure of system information blocks (SIBs).

FIG. 2 illustrates components of a network and the case where segmentation of a SIB is performed outside the base station (gNB), e.g., in a Location Management Function (LMF).

FIG. 3 illustrates components of a network and the case where segmentation is done inside the base station (gNB).

FIG. 4 illustrates two different examples of gNB structure, for gNBs supporting multiple cells.

FIG. 5 is a process flow diagram illustrating an example method, as performed by a wireless device.

FIG. 6 is a process flow diagram illustrating an example method as performed by a network node.

FIG. 7 illustrates another example method as performed by a network node.

FIG. 8 shows an example of a communication system, according to some embodiments.

FIG. 9 is a block diagram illustrating an example wireless device, or user equipment (UE), according to some embodiments.

FIG. 10 illustrates a network node, according to some embodiments.

FIG. 11 is a block diagram showing components of an example host server, according to some embodiments.

FIG. 12 illustrates features of an example virtualization environment.

FIG. 13 is a communication diagram illustrating a host communicating via a network node with a UE, over a partially wireless connection.

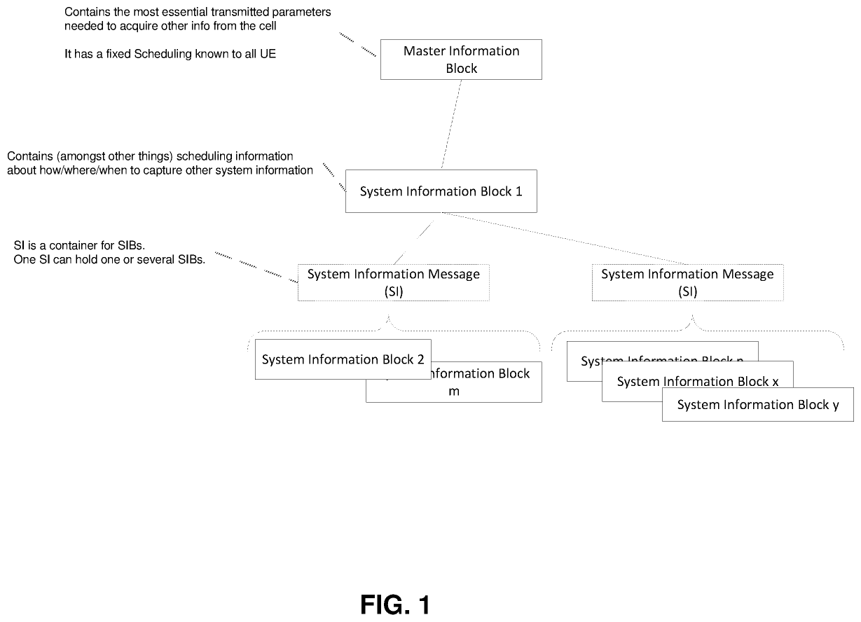

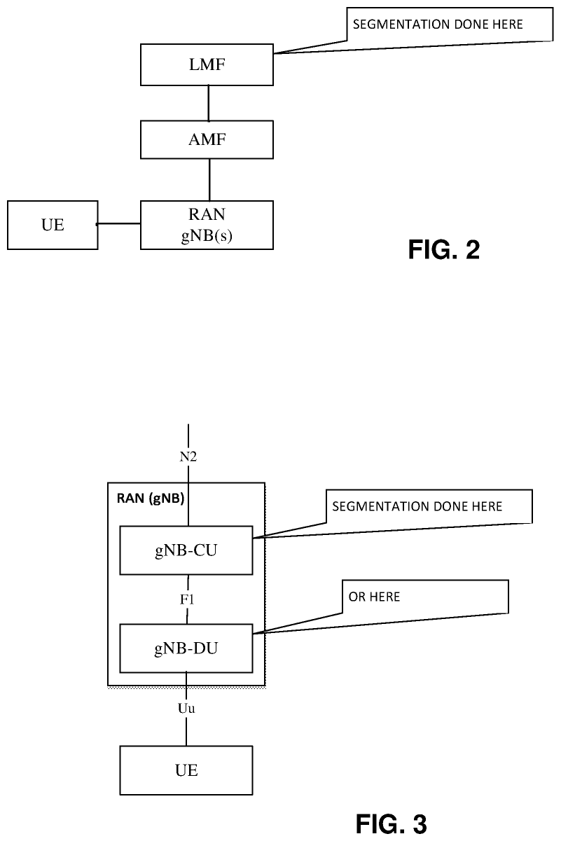

### DETAILED DESCRIPTION

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

For the sake of simplicity, the gNB-external segmentation process, e.g., the one used by the LMF for positioning assistance data, is not discussed in detail herein, as typically a single LMF uses the same segmentation process throughout the NW/Cells. However, it shall be understood that the ideas herein are equally relevant for deployments in which an external entity (i.e., an entity other than the gNB/base station) chooses to perform a differentiated segmentation process applicable to different areas/nodes. Hence, the description of the present invention focuses on methods for the gNB (CU and/or DU) to inform the UE about applicability of segment concatenation across cells, whereby the UE uses the information to, rather than discard segments across cells, concatenate them.

Furthermore, the ideas described herein should be understood as distinct from the currently 3GPP existing SIB validity (“valueTag”). This valueTag is only related to the content (complete information) of a SIB, rather than to the segmentation process or to any given segment of the message.

As noted above, there remain challenges with the segmentation of SIBs as previously specified by 3GPP. For example, 3GPP does not specify details of the segmentation process, and leaves it open for NW implementation. It is only specified that there can be a maximum of 64 segments for a segmented SIB and that the maximum size for an SI message (containing the segmented SIB) is 2976 bits. The details of the segmentation process are important, however, as they affect provision of services to the end users. Large segments (or no segmentation at all) result in large transport blocks. The larger the transport block, the more often the gNB-DU may need to repeat the broadcast message within the SI-window, to achieve high coding gain, depending on available time/frequency resources in order to guarantee service provision at cell edge. On the other hand, the smaller each segment is (i.e., the more segments there are for a given message), the longer time it takes to deliver the complete contents of the SI message to the UEs. Especially for PWS (SIB7, and SIB8), it is crucial that UEs, irrespective of their locations in the cell, receive a complete warning message as soon as possible.

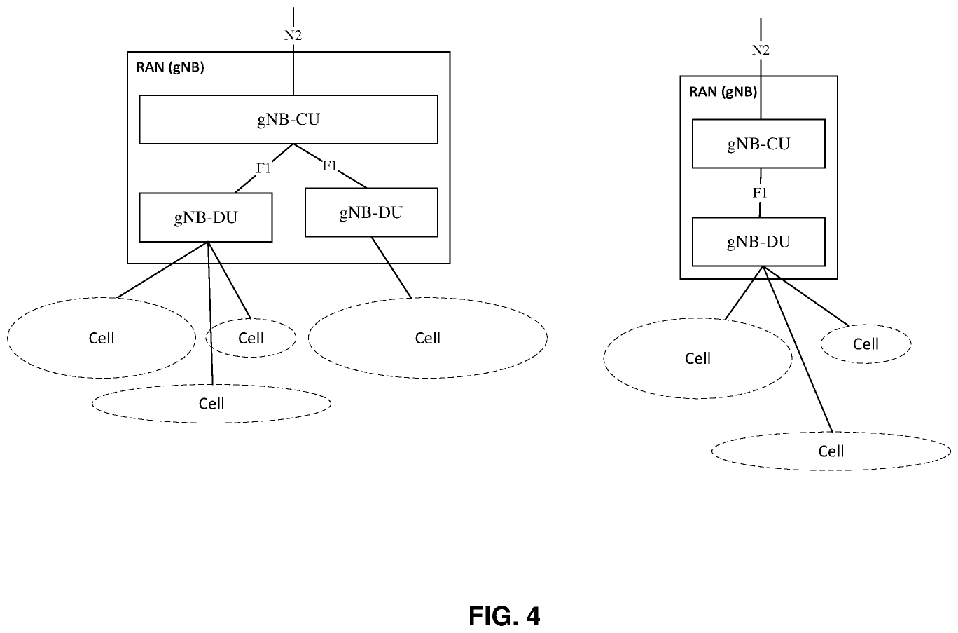

A gNB typically hosts multiple cells. These cells may have different characteristics and/or be hosted by different HW/SW entities (gNB-DUs), as shown in FIG. 4. As a result, the segmentation process may be done differently, and potentially uniquely, per cell, even for the very same message. For example, in the case where the segmentation is done within a gNB-CU connected to multiple gNB-DUs (left part of FIG. 4), the gNB-CU may, in some instances, perform the segmentation differently for the two connected gNB-DUs. Likewise, in the case where the segmentation is done within the gNB-DU, the segmentation may in some instances have been done differently for one/multiple hosted cells.

For the sake of simplicity, the details of gNB-external segmentation process are not discussed herein, as those details are not necessary for a complete understanding of the presently disclosed techniques. It is here assumed that one single LMF entity is used throughout the NW, carrying out the very same segmentation process for a SIB to be broadcast over many or all cells of the NW. However, when it comes to the gNB-internal segmentation (used currently for SIBs 7, 8, and 12), as a result of said potentially different segmentation process, a UE during mobility between cells cannot rely on that the segments broadcast in one cell can be concatenated to segments broadcast in another cell. Hence, according to the specifications, during mobility between different cells the UE shall throw away segments gathered from previous cell and reacquire and concatenate all segments in the new cell. See excerpts from 3GPP TS 38.331:
Related to PWS SIBs (SIB7/8): “The UE may use a valid stored version of the SI except MIB, SIB1, SIB6, SIB7 or SIB8 e.g., after cell re-selection.”
Related to Sidelink SIB (SIB12): “The UE shall discard any stored segments for SIB12 upon cell (re-) selection.”

As a result, UEs involved in frequent cell reselections in relation to number of segments and associated broadcast rate (e.g., UEs in high speed, or UEs on cell edge reselecting back and forth between cells), will suffer from delayed acquisition time or may be unable to complete the acquisition at all, due to constant deletion and reacquisition/reassembly of segments before the information is presented to higher layers/user. Such delays, especially in the case of PWS, are highly undesirable and therefor there is a need for improved methods to remedy the issue.

In one aspect of the presently disclosed techniques, for each of one or more broadcast SIBs, the NW informs the UE of whether cross-cell concatenation is allowed/applicable. For example, in one embodiment, the SI-SchedulingInfo of SIB1 can be extended by an information element “segmentationAreaId” (e.g., a bit string) per SIB type subject to segmentation. For instance, in the current specifications, since SIBs 7, 8, and 12 are subject to segmentation, a segmentationAreaId is defined for each. Alternatively, one or more segmentationAreaId(s) may be introduced, each specifying a list of which SIBs the segmentationAreaId(s) are applicable to. In one embodiment, instead of introducing a new identifier, other already existing identifiers (e.g., systemInformationAreaID, Tracking Area ID, RAN Id, or the like) are used, and the UEs are informed to use an existing identifier (ID) as the basis for cross-cell segmentation (i.e., cross-cell segmentation is allowed throughout the cells with same ID).

In one aspect of the present invention, the segmentationAreaIds are coordinated between various gNBs to make sure that they are unique, in case different segmentation processes are used. In another aspect of the present invention, either partially (e.g., only some bits) or fully the segmentationAreaId is based on a unique identifier such as gNB Identifier (gNB ID) or the like, to ensure uniqueness in case different segmentation processes are used in the various gNBs.

In yet another aspect of the present invention, the segmentation processes are communicated/negotiated between different gNBs and, if agreed to use the same segmentation process, the same segmentationAreaId is then broadcast in cells of said gNBs.

In one aspect, if the segmentationAreaId is omitted, then the UEs shall interpret the omission as an instruction that no cross-cell concatenation is allowed. In another embodiment, a separate information element explicitly informs the UEs whether cross-cell concatenation is allowed/disallowed.

In another aspect of the present invention, the NW node responsible for the segmentation process informs another NW node that the same segmentation process has been used for multiple cells. For example, a gNB-CU informs the gNB-DUs (e.g., via the F1 interface) that the same segmentation process has been used among the cells hosted by gNB-DUs. For instance, the F1 interface may be extended to carry a segmentationAreaId and the same segmentation area id/value is provided to more than one gNB-DU. Each gNB-DU further broadcasts the segmentationAreaId information to the UEs of the cells hosted by it.

In all aspects, the UE, based on NW provided information, if allowed and if the segmentation areas of segments acquired in different cells match, continues to concatenate segments when moving between cells rather than using the currently specified process of restarting and discarding previously acquired segments from another cell.

These techniques may roughly be understood as including the following:
1. Methods for the NW to inform the UE that the same system information segmentation process has been used in more than one cell.
   a. Said information is provided as part of broadcast system information.
   b. The information is implemented by introducing a segmentation area. A UE may perform cross-cell segment concatenation within cells belonging to the same segmentation area e.g., having the same segmentation value/id. In one aspect introducing such new identity (e.g., segmentationAreaID), in another reusing other existing IDs. E.g., The segmentation area, where the #segments and segment content is identical, may use the area ID for which the SIBx content is the same (i.e., same systemInformationAreaID) or be associated with a certain TA code(s) or RAN area code(s) or potentially a new area ID specific for a certain SIB (e.g., pws-SegmentationAreaID).
   c. The information may individually be configured per SIB/SI rather than applicable to all segmented SIBs broadcast in a cell. For example, different SIBs may belong to different segmentation areas (e.g., one which is segmented by gNB-CU whereas another segmented by gNB-DU), or e.g., only certain SIB(s) is/are subject to cross-cell concatenation.
2. Methods for a first NW node responsible for SIB segmentation process to inform a second NW node that the same segmentation process has been used, whereby the second NW node forwards the said segmentation process information to the receiving UE.
   d. For example, a gNB-CU informs the gNB-DUs via the F1 interface that same segmentation process has been used among the gNB-DUs. For example, the same segmentation area value is provided to more than one gNB-DU whereby each gNB-DU further broadcasts the information to the UEs of the cells hosted by it.
   e. And/or, e.g., a gNB-CU coordinates the segmentationProcess/AreaId with another gNB-CU via an Xn interface so that the same process and (in case same segmentation process/method is used in both) SegmentationAreaId is broadcast in the cells hosted by the two gNBs and when different segmentation process is used different SegmentationAreaId(s) are broadcast in the cells of the two gNBs.
3. Methods for the UE to, based on said new information related to segmentation, if applicable, continue to concatenate segments to previously acquired segments from other cell(s).

Given the description above, it should be understood that the term “segmentation area” means the area covered by cells having the same segmentation area identifier, or segmentation area “ID.” Typically, but not necessarily, this segmentation area will encompass several, perhaps many, geographically contiguous cell coverage areas. Likewise, the term “segmentation area ID” refers to an identifier associated with each cell in a given segmentation area, where this segment area identifier may have on or multiple parts, and may correspond fully or partially to an already existing identifier known by the UE and the gNBs to correspond to certain cells and/or correspond fully or partially to a new identifier.

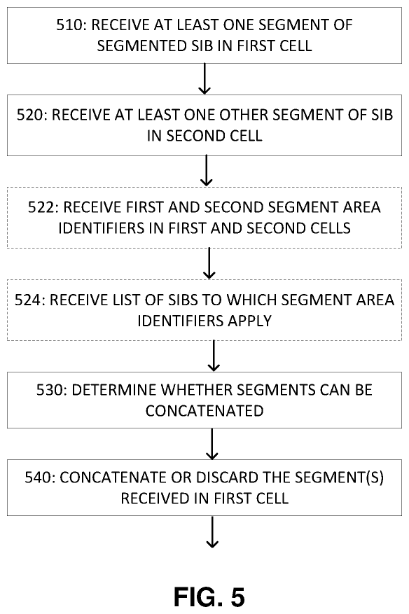

In view of the detailed explanation and examples provided above, it will be appreciated that FIG. 5 is a process flow diagram illustrating an example method, performed by a user equipment, for receiving system information messages from a wireless network according to some embodiments of the presently disclosed techniques. As shown at blocks 510 and 520, the illustrated method comprises the steps of receiving at least one segment of a segmented SIB in a first cell and receiving at least one other segment of the SIB in a second cell. Note that here the method is focused on different segments of the same SIB, as received in first and second cells, respectively, e.g., when the UE moves from the first cell to the second cell. The same technique can apply to multiple segmented SIBs at the same time, of course.

The method further comprises, as shown at block 530, the step of determining, based on information received from the wireless network, whether the at least one segment of the SIB received in the first cell can be concatenated with the at least one other segment of the SIB received in the second cell. Put differently, the UE determines whether the same segmentation of the SIB applies to the segments as transmitted in the first and second cells. As shown at block 540, depending on this information, the UE either concatenates the at least one segment received in the first cell with the at least one other segment received in the second cell, to form the SIB, or discards the at least one segment received in the first cell, depending on said information.

In some embodiments, the information received by the UE to determine whether the segments received in the first and second cells can be concatenated comprises a first segment area identifier associated with the at least one segment of the SIB received in the first cell and a second segment area identifier associated with the at least one other segment of the SIB received in the second cell. In these embodiments, the determining shown in block 530 comprises determining that the at least one segment of the SIB received in the first cell can be concatenated with the at least one other segment of the SIB received in the second cell in response to determining the first segment area identifier matches the second segment area identifier. Note that while the term “segment area identifier” is used here, this identifier is not necessarily associated with a specific, fixed, area, but instead is meant to identify a group of cells that are using the same segment for the SIB. In some cases, areas in which given segment area identifiers are used may physically overlap.

The first and second segment area identifiers in the embodiments discussed just above may be included in SIB1 messages received from the first and second cells, respectively. Block 522 in FIG. 5 illustrates a step of receiving such segment area identifiers. The first and second segment area identifiers may correspond to a predetermined field designated as a segment area identifier, e.g., a new segmentAreaID, in some embodiments. These first and second segment area identifiers may be specific to a particular SIB, in some embodiments, or may apply more generally to all SIBs. In some embodiments, as shown at block 524, the method may comprise receiving, in association with the first and second segment area identifiers, a list of one or more SIBs to which the first and second segment area identifiers apply. In such embodiments, different segment area identifiers may apply to different segmented SIBs.

In some embodiments, the method may comprise receiving, from the wireless network, an indication that an identifier or field included in each SIB1 is to be reused as a segment area identifier. In this case, a new segment area identifier field or element may not be required.

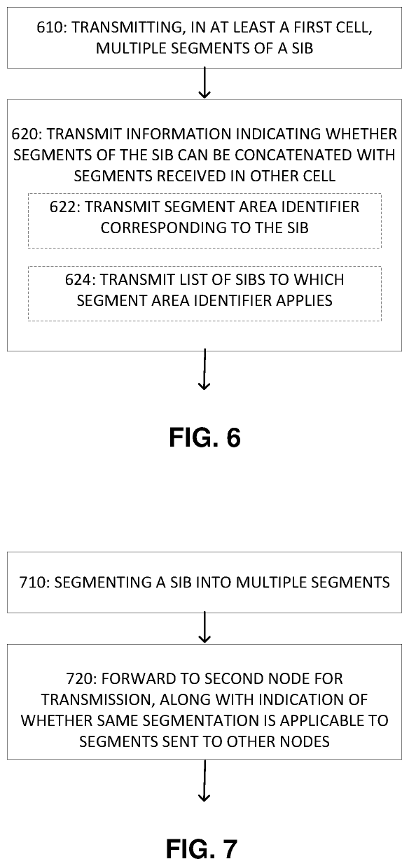

FIG. 6 illustrates a method performed by a network node, such as a gNB, for providing system information to a UE. This method may be understood as complementing the UE methods described above.

As shown at block 610, the method comprises transmitting, in at least a first cell, multiple segments of a system information block, SIB. As shown at block 620, the method further comprises transmitting information indicating whether segments of the SIB transmitted in the first cell can be concatenated by a UE with one or more segments of the SIB received by the UE in a second cell.

In some embodiments, the information comprises a first segment area identifier associated with multiple segments of the SIB transmitted in the first cell, such that the segments of the SIB received in the first cell can be concatenated with one or more segments of the SIB received in the second cell in the event that the first segment area identifier matches a second segment area identifier received by the UE in the second cell. A step of transmitting such a segment area is shown at block 622 in FIG. 6. As in the examples discussed above in connection with FIG. 5, the first segment area identifier may be included in a SIB1 message transmitted in the first cell and may correspond to a predetermined field designated as a segment area identifier, for example, such as a segmentAreaID.

In some embodiments, the first segment area identifier may comprise a first portion unique to the network node, among a group of network nodes including the network node. This may be done to ensure that there is no accidental reuse among nodes that are actually using different segmentations of the SIB.

In some embodiments, the first segment area identifier is specific to the SIB. In some embodiments, the method may comprise transmitting, in association with the first segment area identifier, a list of one or more SIBs to which the first segment area identifier applies. This is shown at block 624 in FIG. 6.

In some embodiments where a dedicated field or identifier is not used, the method may comprise transmitting an indication that an identifier or field already included in the SIB1 is to be reused as a segment area identifier.

In some embodiments, the method shown in FIG. 6 may comprise receiving the multiple segments of the SIB, or receiving the first segment area identifier, or receiving both the multiple segments of the SIB and the first segment area identifier, from a second network node, before transmitting them to the UE. This may be the case, for example, where the network node is a distributed unit of a base station and the second network node is a central unit of the base station. This is not shown in FIG. 6, but the corresponding technique carried out by the other network node is shown in FIG. 7.

More particularly, FIG. 7 illustrates an example method performed by a first network node for providing system information to a UE. As shown at block 710, the method comprises the step of segmenting a SIB into multiple segments. As shown at block 720, the method comprises forwarding the multiple segments to a second network node for transmission to the UE, along with an indication of whether the same segmentation of the SIB is applicable to segments of the SIB sent to one or more other network nodes.

In some embodiments, the indication comprises a first segment area identifier for transmission by the second network node in association with the multiple segments, such that segments received by the UE can be concatenated with one or more segments of the SIB received in a second cell in the event that the first segment area identifier matches a second segment area identifier received by the UE in the second cell.

The methods illustrated above are example embodiments of the inventive techniques described herein. Other embodiments are corresponding apparatuses and systems. Following is a description of various systems and apparatuses; it will be appreciated that the UEs and network nodes described below and illustrated in the accompanying figures may be configured or adapted to carry out all or portions of the techniques described herein, including those illustrated in FIGS. 5-7.

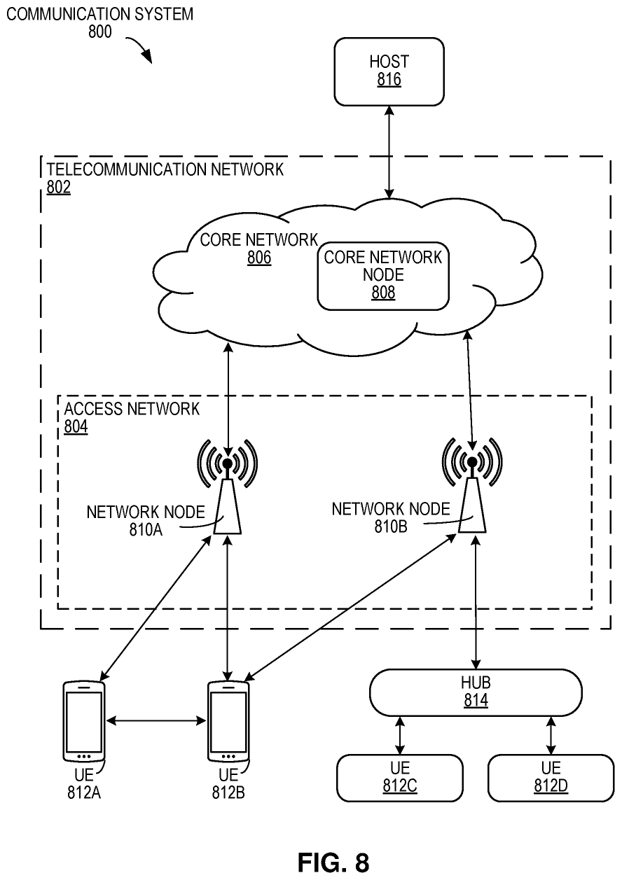

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3^{rd} Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

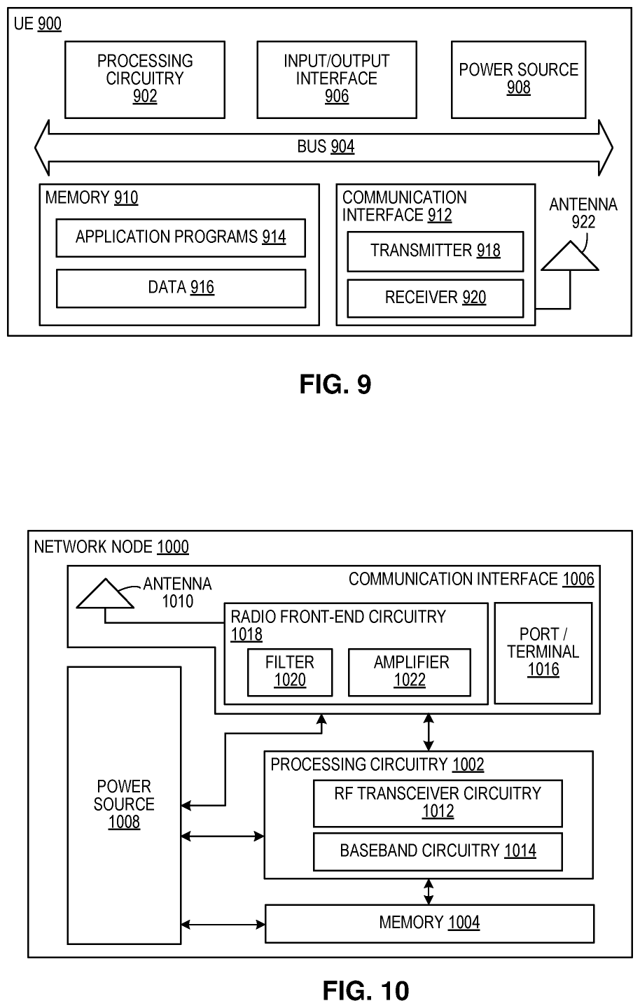

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, the term network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

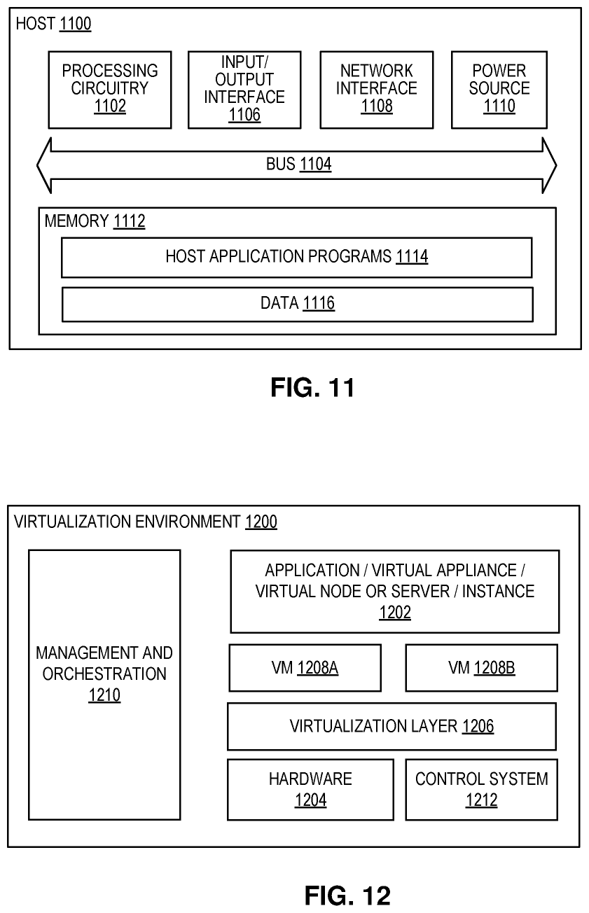

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g., such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

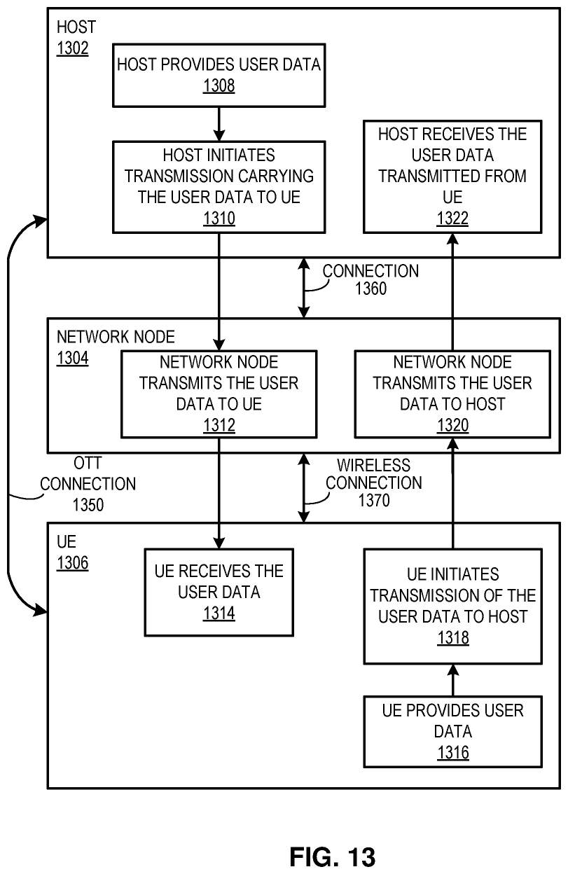

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302.

In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the provision of certain system information, such as EWTS, CMAS, or other PWS messages may be considered an OTT service, and the teachings of these embodiments may reduce delays associated with the delivery of these messages, especially for highly mobile devices, and thereby provide benefits such as reduced user waiting time for what might be very important public warning information.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

### EXAMPLE EMBODIMENTS

Embodiments of the presently disclosed techniques, apparatuses, and systems include, but are not limited to, the following enumerated examples.

### Group A Embodiments

1. A method performed by a user equipment for receiving system information messages from a wireless network, the method comprising:
receiving at least one segment of a segmented system information block, SIB, in a first cell;
receiving at least one other segment of the SIB in a second cell;
determining, based on information received from the wireless network, whether the at least one segment of the SIB received in the first cell can be concatenated with the at least one other segment of the SIB received in the second cell; and
concatenating the at least one segment received in the first cell with the at least one other segment received in the second cell, to form the SIB, or discarding the at least one segment received in the first cell, depending on said information.

2. The method of embodiment 1, wherein the information comprises a first segment area identifier associated with the at least one segment of the SIB received in the first cell and a second segment area identifier associated with the at least one other segment of the SIB received in the second cell, and wherein said determining comprises determining that the at least one segment of the SIB received in the first cell can be concatenated with the at least one other segment of the SIB received in the second cell in response to determining the first segment area identifier matches the second segment area identifier.

3. The method of embodiment 2, wherein the first and second segment area identifiers are included in SIB1 messages received from the first and second cells, respectively.

4. The method of embodiment 3, wherein the first and second segment area identifiers correspond to a predetermined field designated as a segment area identifier.

5. The method of any of embodiments 2-4, wherein the first and second segment area identifiers are specific to the SIB.

6. The method of embodiments 2-4, wherein the method comprises receiving, in association with the first and second segment area identifiers, a list of one or more SIBs to which the first and second segment area identifiers apply.

7. The method of embodiment 3, wherein the method comprises receiving, from the wireless network, an indication that an identifier or field included in each SIB1 is to be reused as a segment area identifier.

8. The method of any of the previous embodiments, further comprising:
providing user data; and forwarding the user data to a host via the transmission to the network node.

### Group B Embodiments

9. A method performed by a network node for providing system information to a user equipment, UE, the method comprising:
transmitting, in at least a first cell, multiple segments of a system information block, SIB; and
transmitting information indicating whether segments of the SIB transmitted in the first cell can be concatenated by a UE with one or more segments of the SIB received by the UE in a second cell.

10. The method of embodiment 9, wherein the information comprises a first segment area identifier associated with multiple segments of the SIB transmitted in the first cell, such that the segments of the SIB received in the first cell can be concatenated with one or more segments of the SIB received in the second cell in the event that the first segment area identifier matches a second segment area identifier received by the UE in the second cell.

11. The method of embodiment 10, wherein the first segment area identifier is included in a SIB1 message transmitted in the first cell.

12. The method of embodiment 11, wherein the first segment area identifier corresponds to a predetermined field designated as a segment area identifier.

13. The method of embodiment 12, wherein the first segment area identifier comprises a first portion unique to the network node, among a group of network nodes including the network node.

14. The method of any of embodiments 10-13, wherein the first segment area identifier is specific to the SIB.

15. The method of any of embodiments 10-13, wherein the method comprises transmitting, in association with the first segment area identifier, a list of one or more SIBs to which the first segment area identifier applies.

16. The method of embodiment 11, wherein the method comprises transmitting an indication that an identifier or field included in the SIB1 is to be reused as a segment area identifier.

17. The method of any of embodiments 10-16, wherein the method further comprises receiving the multiple segments of the SIB, or receiving the first segment area identifier, or receiving both the multiple segments of the SIB and the first segment area identifier, from a second network node.

18. The method of embodiment 17, wherein the network node is a distributed unit of a base station and the second network node is a central unit of the base station.

19. A method performed by a first network node for providing system information to a user equipment, UE, the method comprising:
segmenting a system information block, SIB, into multiple segments; and
forwarding the multiple segments to a second network node for transmission to the UE, along with an indication of whether the same segmentation of the SIB is applicable to segments of the SIB sent to one or more other network nodes.

20. The method of embodiment 19, wherein the indication comprises a first segment area identifier for transmission by the second network node in association with the multiple segments, such that segments received by the UE can be concatenated with one or more segments of the SIB received in a second cell in the event that the first segment area identifier matches a second segment area identifier received by the UE in the second cell.

21. The method of any of the previous Group B embodiments, further comprising:
obtaining user data; and
forwarding the user data to a host or a user equipment.

### Group C Embodiments

22. A user equipment for receiving system information messages from a wireless network, the user equipment comprising:
processing circuitry configured to perform any of the steps of any of the Group A embodiments; and
power supply circuitry configured to supply power to the processing circuitry.

23. A network node for providing system information to a user equipment, UE, the network node comprising:
processing circuitry configured to perform any of the steps of any of the Group B embodiments;
power supply circuitry configured to supply power to the processing circuitry.

24. A user equipment (UE) for receiving system information messages from a wireless network, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

25. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

26. The host of the previous embodiment, wherein the cellular network further includes a network node configured to communicate with the UE to transmit the user data to the UE from the host.

27. The host of the previous 2 embodiments, wherein:
the processing circuitry of the host is configured to execute a host application, thereby providing the user data; and
the host application is configured to interact with a client application executing on the UE, the client application being associated with the host application.

28. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

29. The method of the previous embodiment, further comprising:
at the host, executing a host application associated with a client application executing on the UE to receive the user data from the UE.

30. The method of the previous embodiment, further comprising:
at the host, transmitting input data to the client application executing on the UE, the input data being provided by executing the host application,
wherein the user data is provided by the client application in response to the input data from the host application.

31. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

32. The host of the previous embodiment, wherein the cellular network further includes a network node configured to communicate with the UE to transmit the user data from the UE to the host.

33. The host of the previous 2 embodiments, wherein:
the processing circuitry of the host is configured to execute a host application, thereby providing the user data; and
the host application is configured to interact with a client application executing on the UE, the client application being associated with the host application.

34. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

35. The method of the previous embodiment, further comprising:
at the host, executing a host application associated with a client application executing on the UE to receive the user data from the UE.

36. The method of the previous embodiment, further comprising:
at the host, transmitting input data to the client application executing on the UE, the input data being provided by executing the host application,
wherein the user data is provided by the client application in response to the input data from the host application.

37. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

38. The host of the previous embodiment, wherein:
the processing circuitry of the host is configured to execute a host application that provides the user data; and
the UE comprises processing circuitry configured to execute a client application associated with the host application to receive the transmission of user data from the host.

39. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

40. The method of the previous embodiment, further comprising, at the network node, transmitting the user data provided by the host for the UE.

41. The method of any of the previous 2 embodiments, wherein the user data is provided at the host by executing a host application that interacts with a client application executing on the UE, the client application being associated with the host application.

42. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

43. The communication system of the previous embodiment, further comprising:
the network node; and/or
the user equipment.

44. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

45. The host of the previous 2 embodiments, wherein:
the processing circuitry of the host is configured to execute a host application, thereby providing the user data; and
the host application is configured to interact with a client application executing on the UE, the client application being associated with the host application.

46. The host of the any of the previous 2 embodiments, wherein the initiating receipt of the user data comprises requesting the user data.

47. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

48. The method of the previous embodiment, further comprising at the network node, transmitting the received user data to the host.

### REFERENCES

1. 3GPP 23.273 “5G System (5GS) Location Services (LCS)”
2. 3GPP 38.300 “NR and NG-RAN Overall Description”
3. 3GPP 38.473 “F1 Application Protocol (F1AP)”
4. 3GPP 38.331 “Radio Resource Control (RRC) protocol specification”

1-29. (canceled)

30. A method performed by a user equipment for receiving system information messages from a wireless network, the method comprising:
receiving at least one segment of a segmented system information block (SIB) in a first cell;
receiving at least one other segment of the SIB in a second cell, differing from the first cell;
determining, based on information received from the wireless network, whether the at least one segment of the SIB received in the first cell can be concatenated with the at least one other segment of the SIB received in the second cell; and
concatenating the at least one segment received in the first cell with the at least one other segment received in the second cell, to form the SIB, or discarding the at least one segment received in the first cell, depending on said information.

31. The method of claim 30, wherein the information comprises a first segment area identifier associated with the at least one segment of the SIB received in the first cell and a second segment area identifier associated with the at least one other segment of the SIB received in the second cell, and wherein said determining comprises determining that the at least one segment of the SIB received in the first cell can be concatenated with the at least one other segment of the SIB received in the second cell in response to determining the first segment area identifier matches the second segment area identifier.

32. The method of claim 31, wherein the first and second segment area identifiers are included in SIB1 messages received from the first and second cells, respectively.

33. The method of claim 31, wherein the method comprises receiving, in association with the first and second segment area identifiers, a list of one or more SIBs to which the first and second segment area identifiers apply.

34. The method of claim 32, wherein the method comprises receiving, from the wireless network, an indication that an identifier or field included in each SIB1 is to be reused as a segment area identifier.

35. A method performed by a network node for providing system information to a user equipment (UE), the method comprising:
transmitting, in at least a first cell, multiple segments of a system information block, SIB; and
transmitting information indicating whether segments of the SIB transmitted in the first cell can be concatenated by a UE with one or more segments of the SIB received by the UE in a second cell.

36. The method of claim 35, wherein the information comprises a first segment area identifier associated with multiple segments of the SIB transmitted in the first cell, such that the segments of the SIB received in the first cell can be concatenated with one or more segments of the SIB received in the second cell in the event that the first segment area identifier matches a second segment area identifier received by the UE in the second cell.

37. The method of claim 36, wherein the first segment area identifier is included in a SIB1 message transmitted in the first cell.

38. The method of claim 37, wherein the first segment area identifier corresponds to a predetermined field designated as a segment area identifier and comprises a first portion unique to the network node, among a group of network nodes including the network node.

39. The method of claim 36, wherein the first segment area identifier is specific to the SIB.

40. The method of claim 36, wherein the method comprises transmitting, in association with the first segment area identifier, a list of one or more SIBs to which the first segment area identifier applies.

41. The method of claim 36, wherein the method comprises transmitting an indication that an identifier or field included in the SIB1 is to be reused as a segment area identifier.

42. The method of claim 36, wherein the method further comprises receiving the multiple segments of the SIB, or receiving the first segment area identifier, or receiving both the multiple segments of the SIB and the first segment area identifier, from a second network node.

43. The method of claim 42, wherein the network node is a distributed unit of a base station and the second network node is a central unit of the base station.

44. A method performed by a first network node for providing system information to a user equipment (UE), the method comprising:
segmenting a system information block (SIB) into multiple segments; and
forwarding the multiple segments to a second network node for transmission to the UE, along with an indication of whether the same segmentation of the SIB is applicable to segments of the SIB sent to one or more other network nodes.

45. The method of claim 44, wherein the indication comprises a first segment area identifier for transmission by the second network node in association with the multiple segments, such that segments received by the UE can be concatenated with one or more segments of the SIB received in a second cell in the event that the first segment area identifier matches a second segment area identifier received by the UE in the second cell.

46. A user equipment (UE) for receiving system information messages from a wireless network, the UE comprising:
a transmitter and receiver; and
processing circuitry operatively coupled to the transmitter and receiver and configured to:
receive at least one segment of a segmented system information block (SIB) in a first cell, via the receiver;
receive at least one other segment of the SIB in a second cell, via the receiver;
determine, based on information received from the wireless network, whether the at least one segment of the SIB received in the first cell can be concatenated with the at least one other segment of the SIB received in the second cell; and
concatenate the at least one segment received in the first cell with the at least one other segment received in the second cell, to form the SIB, or discard the at least one segment received in the first cell, depending on said information.

47. A network node for providing system information to a user equipment (UE), the network node comprising:
radio circuitry configured to communicate with the UE; and
processing circuitry operatively coupled to the radio circuitry and configured to:
transmit in at least a first cell, via the radio circuitry, multiple segments of a system information block, SIB; and
transmit, via the radio circuitry, information indicating whether segments of the SIB transmitted in the first cell can be concatenated by a UE with one or more segments of the SIB received by the UE in a second cell.

48. A first network node for providing system information to a user equipment (UE), the first network node comprising:
radio circuitry configured to communicate with the UE; and
processing circuitry operatively coupled to the radio circuitry and configured to:
segment a system information block (SIB) into multiple segments; and
forward the multiple segments to a second network node for transmission to the UE, along with an indication of whether the same segmentation of the SIB is applicable to segments of the SIB sent to one or more other network nodes.

49. The first network node of claim 48, wherein the indication comprises a first segment area identifier for transmission by the second network node in association with the multiple segments, such that segments received by the UE can be concatenated with one or more segments of the SIB received in a second cell in the event that the first segment area identifier matches a second segment area identifier received by the UE in the second cell.
